(19) United States
(12) Patent Application Publication
(10) Pub. No.: US 2010/0040865 A1
(43) Pub. Date: Feb. 18, 2010

(54) OPTICAL FILTER AND METHOD FOR MANUFACTURING SAME

(76) Inventor: Takeshi Kinoshita, Chiba (JP)

Correspondence Address: HOWARD & HOWARD ATTORNEYS PLLC, 450 West Fourth Street, Royal Oak, MI, 48067, US

(21) Appl. No.: 12/443,308

(22) PCT Filed: Sep. 28, 2007
(86) PCT No.: PCT/JP2007/069089

§ 371 Date: Mar. 27, 2009

(30) Foreign Application Priority Data
Sep. 28, 2006 (JP) 2006-264554

(51) Int. Cl. G02B 5/22; B05D 5/06

(52) U.S. Cl. 428/323; 428/408; 427/162; 427/164; 977/742; 977/902

(57) ABSTRACT

An optical filter (10) is constituted by a flat plate (11), a rotation pin (12), and an actuation pin (13). The flat plate (11) includes a transparent substrate (31), a resin layer (32) formed on the transparent substrate (31), and a CNT layer (33) formed on the resin layer (32). The CNT layer (33) is disposed on the outermost layer. CNTs dispersed in the CNT layer (33) have a characteristic of more absorbing light that has a short wavelength. Therefore, by forming the CNT layer (33) on the outermost layer, it is possible to weaken the intensity of ultraviolet that is to reach the resin layer (32), and to prevent deterioration of a dye dispersed in the resin layer (32). Hence, the optical filter (10) acquires a satisfactory environment resistance.

### TECHNICAL FIELD

The present invention relates to an optical filter that uses carbon nanotubes, and a method for manufacturing the same.

### BACKGROUND ART

Optical filters have conventionally been used in cameras, video camcorders, or other imagers on shooting in an environment with bright light. The optical filers include Neutral Density filters (ND filters) that reduce only the intensity of light entering the imagers at a specific rate in order to change the texture of photos or videos; and InfraRed (IR) cut filters that cut wavelengths in the infrared region.

As disclosed in Patent Literature 1, such optical filters are manufactured by forming on a light-transmissive substrate a film, such as a metal oxide film, having an optical property of absorbing a specific wavelength.

Patent Literature 1: Unexamined Japanese Patent Application KOKAI Publication No. 2006-178395

Patent Literature 2: Unexamined Japanese Patent Application KOKAI Publication No. 2007-187992

### DISCLOSURE OF INVENTION

### Problem to be Solved by the Invention

Filters having such a specific-wavelength absorption property are formed by dispersing a dye or the like in a resin. Inconveniently, dyes are sensitive to ultraviolet and moisture and could deteriorate. Such deterioration will cause changes of the optical property.

There is accordingly a demand for an optical filter that has a preferable environment resistance with protection against ultraviolet- or moisture-caused deterioration so that the change of optical property may not be caused, and a method for manufacturing the same.

Patent Literature 2 describes an optical filter manufactured by forming a nickel layer on a transparent substrate and forming a CNT layer on the nickel layer.

The present invention was made in view of the above circumstances, and an object of the present invention is to provide an optical filter having a preferable environment resistance and a method for manufacturing the same.

### Means for Solving the Problem

To achieve the above object, an optical filter according to a first aspect of the present invention is an optical filter that attenuates light having a predetermined wavelength, and includes:

at least one resin layer containing a material that absorbs light having a predetermined wavelength; and

a carbon layer in which a carbon-based material is dispersed,

wherein the resin layer is formed on one surface of the carbon layer, and light that passes through the carbon layer enters the resin layer.

The resin layer may be formed on a substrate having light transmissivity.

The material that absorbs light having the predetermined wavelength may be polyethylenedioxythiophene.

The carbon-based material may be comprised of carbon nanotubes.

The carbon nanotube may have a diameter of 300 nm or smaller.

The carbon nanotube may be mixed at a rate of 0.01 to 20 weight %.

To achieve the above object, a method for manufacturing an optical filter according to a second aspect of the present invention is a method for manufacturing an optical filter, including:

a resin layer forming step of forming at least one resin layer containing a material that absorbs light having a predetermined wavelength; and

a carbon layer forming step of forming a carbon layer in which a carbon-based material is dispersed on the resin layer,

wherein at the carbon layer forming step, the formation is performed in such a way that the carbon layer is positioned in a light entrance side of the optical filter so that light that passes through the carbon layer enters the resin layer.

The resin layer may be formed on a substrate having light transmissivity.

To achieve the above object, a method for manufacturing an optical filter according to a third aspect of the present invention is a method for manufacturing an optical filter, including:

a carbon layer forming step of forming at least one carbon layer in which a carbon-based material is dispersed; and

a resin layer forming step of forming a resin layer containing a material that absorbs light having a predetermined wavelength, on the carbon layer,

wherein a carbon-resin layer that includes the carbon layer formed at the carbon layer forming step and the resin layer formed at the resin layer forming step is transferred to a substrate having light transmissivity, such that the resin layer and the substrate having light transmissivity contact, and

at the resin layer forming step, the formation is performed in such a way that the carbon layer is positioned in a light entrance side of the optical filter so that light that passes through the carbon layer enters the resin layer.

To achieve the above object, a method for manufacturing an optical filter according to a fourth aspect of the present invention is a method for manufacturing an optical filter, including:

a resin printing step of printing a resin containing a material that absorbs light having a predetermined wavelength, on a substrate having light transmissivity; and

a carbon layer forming step of forming a carbon layer in which a carbon-based material is dispersed, on a surface, on which the resin is printed in the resin printing step, of a printed product,

wherein at the carbon layer forming step, the formation is performed in such a way that the carbon layer is positioned in a light entrance side of the optical filter so that light that passes through the carbon layer enters the resin.

### EFFECT OF THE INVENTION

According to the present invention, it is possible to provide an optical filter that has a preferable environment resistance, by having a layer, in which carbon nanotubes are dispersed, formed on its outermost surface.

### BRIEF DESCRIPTION OF DRAWINGS

FIG. 1(a) is a diagram showing an example configuration of an optical filter according to an embodiment of the present invention, and FIG. 1(b) is a cross section taken along a line I-I shown in FIG. 1 (a).

FIG. 2 is a diagram showing an imaging device mounted with the optical filter according to the embodiment of the present invention.

FIG. 3 is a diagram showing light transmissivity of a dye (organic conductive material) dispersed in a resin layer.

FIG. 4 is a diagram showing light transmissivity of a CNT layer.

FIG. 5 is a diagram showing light transmissivity obtained when a resin layer and a CNT layer are formed on a transparent film.

FIG. 6 is a diagram showing a result of a light stability test on fluorescent films.

FIG. 7 are diagrams showing a modification example of the present invention, where FIG. 7 (a) is a cross section taken along a line III-III of FIG. 7 (b), and FIG. 7 (b) is a cross section taken along a line II-II of FIG. 7 (a).

FIG. 8 (a) is a diagram showing a modification example of the present invention, and FIG. 8 (b) is a cross section taken along a line IV-IV of FIG. 8 (a).

### EXPLANATION OF REFERENCE NUMERALS

10, 70 optical filter
10a, 70a light attenuation region
11, 51, 71 flatplate
12, 72 rotation pin
13, 73 actuation pin
20 imaging device
21a to 21c lens
22 diaphragm
22a aperture
23 filter support substrate
23a opening
24 image sensor
25 substrate
31, 61 transparent substrate
32, 62, 81 resin layer
33, 63, 82 CNT layer

### BEST MODE FOR CARRYING OUT THE INVENTION

An optical filter and a method for manufacturing the same according to an embodiment of the present invention will be explained with reference to the drawings.

In the present embodiment, a Neutral Density filter (ND filter) that reduces only the intensity of light at a specific rate will be explained as an example.

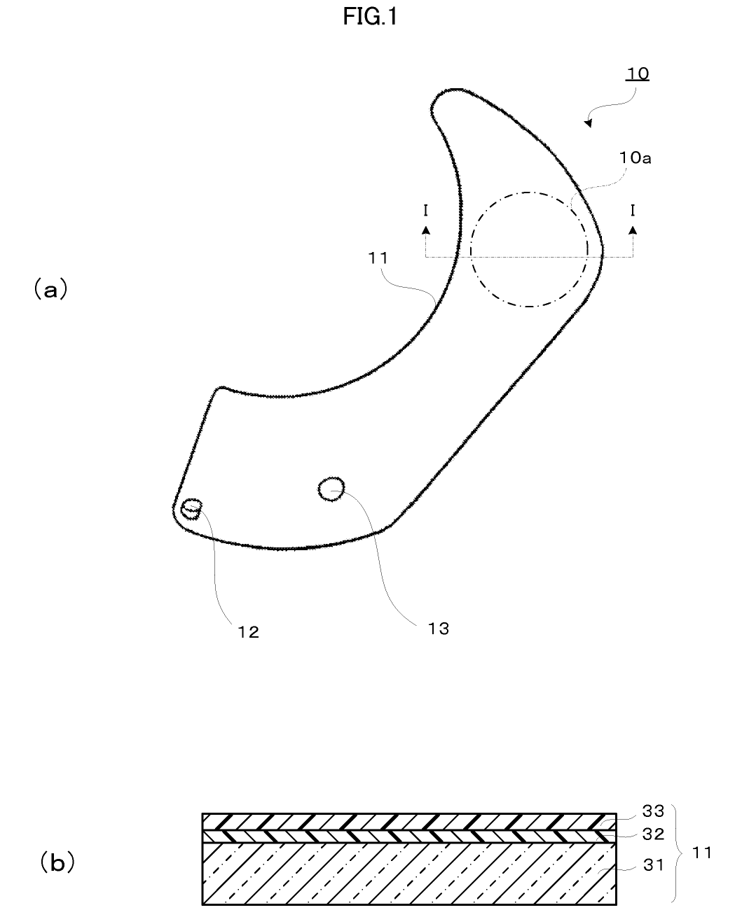

As shown in FIG. 1(a), an optical filter 10 includes a flat plate 11 that has a flat, vane-like shape and a predetermined hardness, a rotation pin 12 that is formed to protrude on the other surface of the flat plate 11, and an actuation pin 13 that is formed on another one end portion of the flat plate 11 and protrudes to the opposite side to the rotation pin 12. When light passes through the region (light attenuation region 10a) of the flat plate 11 that is circled by the one-dot broken line shown in FIG. 1 (a), the intensity of the light is attenuated by a predetermined degree.

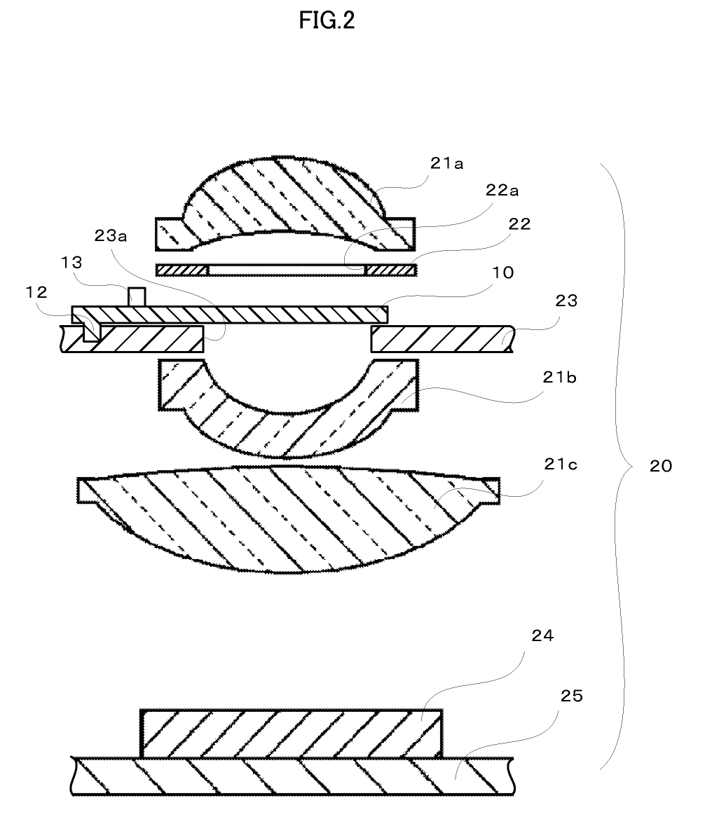

As shown in FIG. 2, the optical filter 10 is set inside an imaging device 20. As shown in FIG. 2, the rotation pin 12 is fitted into a hole in a filter support substrate 23 to serve as a rotation center of the optical filter 10. The actuation pin 13 is formed to protrude to the opposite side to the rotation pin 12. The actuation pin 13 is actuated by an unillustrated actuator to rotate the optical filter 10 about the rotation pin 12. The rotation pin 12 and the actuation pin 13 are formed integrally with the flat plate 11, and, for example, attached to the flat plate 11 by a bonding agent or the like.

As shown in FIG. 2, the imaging device 20 includes lenses 21a to 21c, a diaphragm 22, the optical filter 10, the filter support substrate 23, an image sensor 24, and a substrate 25. The optical filter 10 is provided on the filter support substrate 23 in the imaging device 20. The rotation pin 12 of the optical filter 10 is fitted into a hole formed in the filter support substrate 23. The actuation pin 13 is engaged with an unillustrated actuator. The actuator drives the actuation pin 13, thereby the optical filter 10 rotates about the rotation pin 12. The light attenuation region 10a of the optical filter blocks or uncovers an opening 23a in the filter support substrate 23. In this way, the light attenuation region 10a attenuates the incident light from the lens 21a and the diaphragm 22. Since light rays in the visual light range are attenuated at a substantially equal rate, substantially no influence is given to the color of the light that is to reach the image sensor 24, which may be Charge Coupled Devices (CCD), a Complementary Metal Oxide Semiconductor (CMOS), or the like, provided on the substrate 25.

As shown in FIG. 1 (b), the optical filter 10 includes a transparent substrate 31, a resin layer 32, and a Carbon Nanotube (CNT) layer 33, which constitute the flat plate 11. In the present embodiment, the CNT layer 33, the resin layer 32 and the transparent substrate 31 are layered in the order stated so that the CNT layer 33 is formed to be the outermost layer and to face a light-entrance side. In other words, light passes through the light attenuation region 10a by entering the CNT layer 33, passing through the resin layer 32, and exiting the transparent substrate 31. Hence, the CNT layer 33 is formed on the outermost layer, and light having passed through the CNT layer 33 is guided to the resin layer 32. Hence, the intensity of the ultraviolet included in the light that is to enter the resin layer 32 can be reduced and deterioration of the dye dispersed in the resin layer 32 can be prevented.

As shown in FIG. 2, when the optical filter 10 is at a position to block the opening 23a in the filter support substrate 23, the light attenuation region 10a covers the opening 23a and attenuates light that comes through an aperture 22a in the diaphragm 22. Hence, the light attenuation region 10a has the same area as or a larger area than the opening 23a in the filter support substrate 23 and the aperture 22a in the diaphragm 22.

In the present embodiment, it is necessary that the rate at which incident light to the imaging device 20 is attenuated by passing through the light attenuation region 10a be substantially constant regardless of wavelength. In the present embodiment, it is possible to make the rate, at which light is attenuated, substantially constant regardless of wavelength, by distributing the dye in the resin layer 32 and the CNTs in the CNT layer 33 substantially evenly at least in the light attenuation region 10a.

Since the upper surface of the flat plate 11 is constituted by the CNT layer 33, the upper surface has the bosses and recesses of the carbon nanotubes dispersed in the CNT layer 33. Hence, the upper surface of the flat plate 11 can preferably suppress occurrence of reflection thereon.

The transparent substrate 31 that constitutes the flat plate 11 needs to be light-transparent, and is made of, for example, Poly Ethylene Terephthalate (PET). The transparent substrate 31 has a thickness of, for example, about 100 μm.

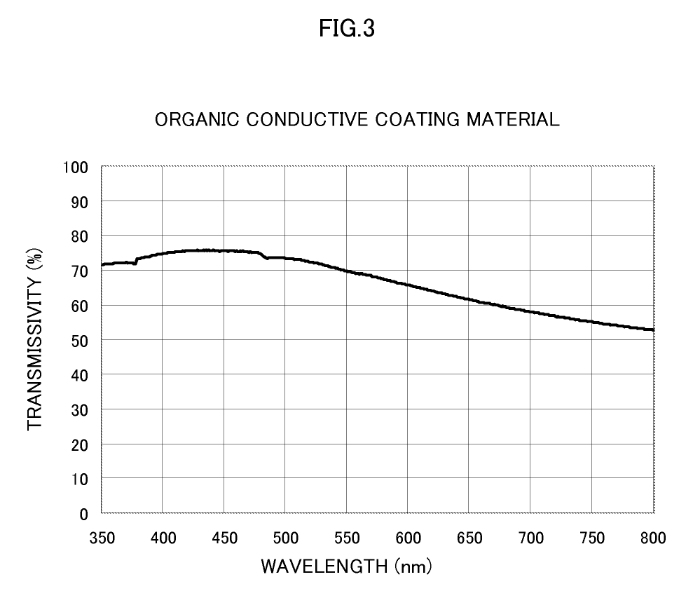

The resin layer 32 is formed between the transparent substrate 31 and the CNT layer 33. The resin layer 32 is made of a light-transparent resin such as PET, in which a predetermined dye made from an organic conductive material or the like is dispersed. The dye to be dispersed may be, for example, polyethylenedioxythiophene (PEDT), which is expressed by the chemical formula shown below. PEDT has an optical property of absorbing light in the long wavelength range more than light in the short wavelength range. Specifically, as shown in FIG. 3, the transmissivity of PEDT is about 75% when the wavelength is 450 nm, at which a peak is marked and after which, the transmissivity gradually decreases from about 75% to about 55% over the wavelength range of 450 nm to 800 nm.

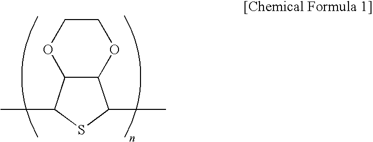

It is possible to lower the transmissivity by dispersing more PEDT in the resin. Furthermore, thickening the resin layer 32 lowers the transmissivity. In this way, by increasing or reducing the amount of the dye to be dispersed and/or by increasing or reducing the thickness of the resin layer 32, it is possible to adjust the optical property, specifically, the light transmissivity (absorptivity), of the resin layer 32. In the present embodiment, the resin layer 32 is formed on the transparent substrate 31 by, for example, printing, coating, etc.

The CNT layer 33 is made of a resin in which carbon nanotubes (CNTs) are dispersed, and formed on the upper surface of the resin layer 32 to have a thickness of, for example, about 0.1 to 100 μm. The carbon nanotubes dispersed in the CNT layer 33 are made of carbon, and each has a hollow cylindrical shape. If the CNTs have a too large diameter, they scatter visible light and become opaque. Therefore, it is advisable to use carbon nanotubes having, for example, a diameter of 10 to 300 nm and a length of 0.1 to 30 μm. The optical filter 10 is required to attenuate any light in the visual light range at an equal rate. The rate at which the optical filter 10 attenuates light is higher as the amount of carbon nanotubes added is larger and lower as this amount is smaller. By taking advantage of this and changing the rate of carbon nanotubes addition, it is possible to adjust the rate of light attenuation required of the optical filter 10. However, if the rate of carbon nanotubes added in the resin increases, the filter material gains a larger viscosity and ultimately becomes difficult to treat for printing, shaping, etc. Accordingly, light attenuation rate and printing/shaping convenience need to be taken into consideration for the amount of carbon nanotubes to be added. In the present embodiment, it is advisable to add carbon nanotubes in an amount of about 0.01 to 20 weight %. In the present embodiment, the CNT layer 33 is formed on the resin layer 32 by printing, coating, etc.

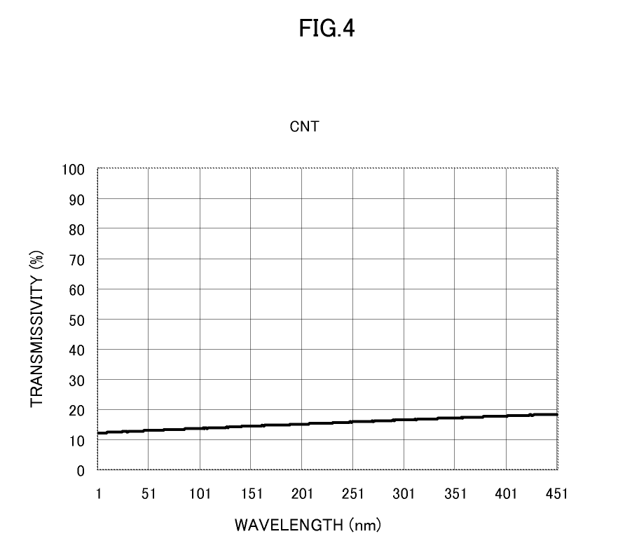

Carbon nanotubes that constitute the CNT layer 33 have an optical property as shown in FIG. 4. As shown in FIG. 4, the light transmissivity of the CNT layer mixed in a transparent resin is about 10% when the wavelength is 350 nm, and becomes higher as the wavelength is longer, to about 20% at the wavelength of 800 nm. Hence, the CNTs show a higher transmissivity at a longer wavelength.

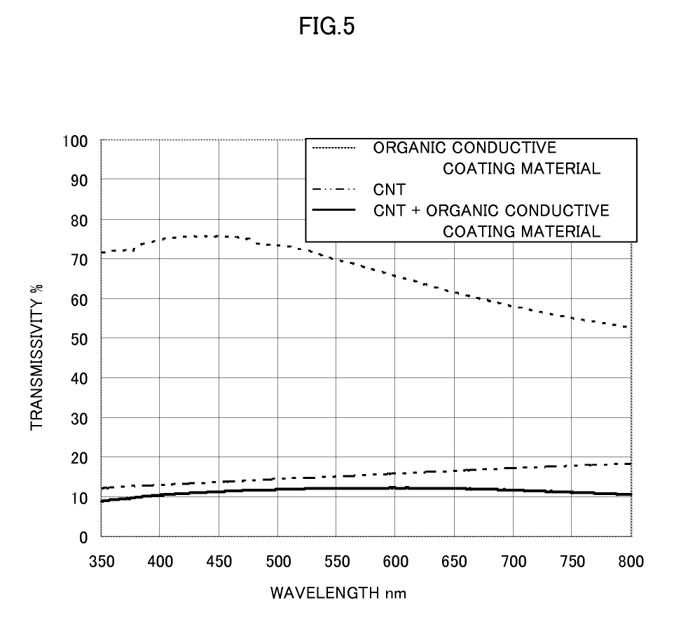

Next, as shown in FIG. 5, it can be understood that the light transmissivity of a transparent film formed of the resin layer 32 and the CNT layer 33 is substantially constant regardless of wavelength, with the overlaying of the resin layer 32 and the CNT layer 33 compensating for the wavelength-dependent transmissivity characteristic of each layer.

As shown in FIG. 4, the CNTs are apt to absorb light in the short wavelength region. Hence, the CNT layer 33 formed on the resin layer 32 attenuates light having a short wavelength (ultraviolet, etc.) that is to reach the resin layer 32. Further, being covered with the CNT layer 33, the resin layer 32 does not contact moisture, etc. Hence, the optical filter 10 can be prevented from deterioration of the resin layer 32 due to ultraviolet, moisture, etc., and can have a preferable environment resistance.

In the optical filter 10 according to the present embodiment, the CNT layer 33 is formed on the resin layer 32 that is formed on the transparent substrate 31. In this way, by forming the CNT layer 33 on the outermost layer, it is possible to make ultraviolet be absorbed by the CNT layer 33. Hence, it is possible to protect the resin layer 32 that contains a dye liable to deteriorate by ultraviolet, and to prevent deterioration of the optical property of the resin layer 32. Accordingly, it is possible to provide an optical filter having a preferable environment resistance.

The CNT layer 33 has absorptivity toward a short wavelength region, specifically, the ultraviolet region. Accordingly, by forming another layer that has absorptivity toward a long wavelength region, it is possible to provide an optical filter having absorptivity that is flat regardless of wavelength.

The upper surface of the optical filter 10 according to the present embodiment is constituted by the CNT layer 33 in which carbon nanotubes are dispersed. Because this imparts a bossed/recessed surface to the CNT layer 33, the optical filter 10 can preferably suppress occurrence of reflection on its surface. Further, since the carbon nanotubes have electric conductivity, the optical filter 10 can preferably hold down its generation of static electricity when it rotates in the imaging device 20 shown in FIG. 2.

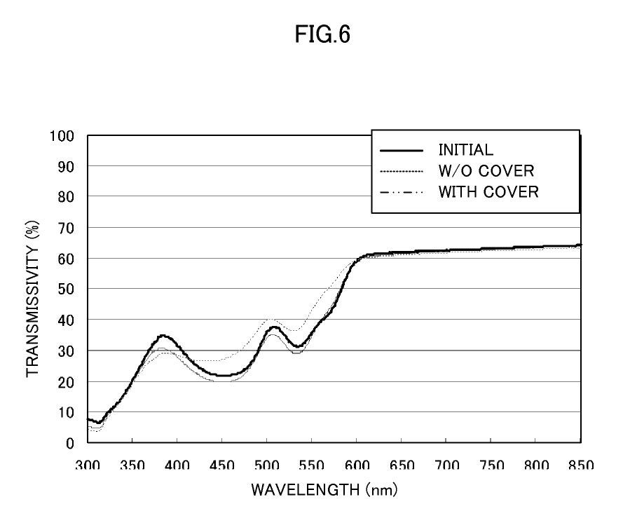

Next, FIG. 6 shows the results of a light stability test on an optic orange filter covered with a CNT layer and one covered with no CNT layer. In the light stability test, the light transmissivity of the optic orange filter in a state of not being covered with a CNT layer was first measured. Next, a filter covered with a CNT layer and a filter covered with no CNT layer were prepared. Then, the filters were irradiated with light for a predetermined time in a predetermined light stability testing apparatus, and changes of the light transmissivity of the filters were measured. The light stability test was conducted under test conditions that the temperature/humidity was a constant temperature/humidity of 40 degrees C. and 90%, a mercury lamp (having a peak wavelength of 365 nm) was used as a UV lamp, the lighting intensity was 3.0 mW/cm², and the irradiation period was 24 hours per day for 7 days.

As shown in FIG. 6, it can be seen that the filter covered with no CNT layer had a light transmissivity that increased over the entirety of a wavelength range from 350 nm to 600 nm. On the other hand, it can be seen that the sample covered with a CNT layer substantially retained the transmissivity of the initial filter, though showing a slight increase of the light transmissivity compared with the initial filter. As obvious from this result, by forming a CNT layer, it is possible to prevent deterioration of the dye dispersed in the filter that is under the CNT layer. Hence, the use of a CNT layer can prevent optical property degeneration.

As described above, the optical filter 10 according to the present embodiment is provided with the CNT layer 33 on its outermost layer to which light enters, and attenuates light having a predetermined wavelength by the CNT layer 33 before guiding the light to the resin layer 32 and the transparent substrate 31. Therefore, the optical filter 10 can prevent the dye dispersed in the resin layer 32 from being deteriorated by ultraviolet, etc. Further, the resin layer 32 is protected from moisture, etc. by being covered with the CNT layer 33. By covering the resin layer 32 with the CNT layer 33, it is possible to preferably prevent degeneration of the optical property of the optical filter 10. Hence, according to the present embodiment, it is possible to provide an optical filter 10 having a preferable environment resistance.

Next, a first method for manufacturing the optical filter 10 according to the present embodiment will be explained.

First, a transparent substrate is prepared. Any kind of transparent substrate may be used as long as it is optically transparent, and, for example, PET is used. The transparent substrate has an area enough to form a plurality of optical filters 10, and a thickness of, for example, 100 μm.

Next, a resin layer is formed on the transparent substrate by coating, printing, etc. such that a dye is dispersed in the resin substantially evenly. The kind and amount of the dye to be dispersed in the resin layer should be appropriately adjusted according to the characteristic required of the optical filter.

Then, CNTs that have been preliminarily produced by a synthesis method such as a vapor growth method are mixed in a binder and stirred to be dispersed evenly. The binder used is a copolymer of fluorine resins, or vinylidene fluoride and propylene hexafluoride, mixed with a solvent or methyl ethyl ketone. Not only fluorine resins, but, other optically transparent materials, for example, polyester, vinyl chloride, silicone, etc. may be used. The CNTs should be preliminarily dispersed in an ion-exchange water so that they can be easily dispersed in the binder. Since CNTs having a too large diameter will scatter visible light and become opaque, CNTs with, for example, a diameter of 10 to 300 nm and a length of 0.1 to 30 μm are used. The CNTs are dispersed in an amount of about 0.01 weight % to 20 weight %.

Then, a screen printing plate or a metal mask that has openings that match the shape of the optical filter is formed on the upper surface of the resin layer, and printing, coating, or the like is applied to the resin layer such that the CNTs dispersed in the binder are printed or coated thereon. When printing or coating is completed, the screen printing plate or the metal mask is removed. Then, burning is conducted, for example, at about 100 degrees C. for about one hour so that the CNTs become a layer. The CNT layer is formed to a thickness of about 0.1 to 100 μm.

Thus, the flat plate 11 of the optical filter 10 is completed. Then, the flat plate 11 is cut into the shape of the optical filter 10, and the rotation pin 12 and the actuation pin 13 are attached to the optical filter 10 with a bonding agent or the like. Thus, the optical filter 10 is completed.

As described above, according to the method for manufacturing of the present embodiment, the resin layer is formed on the transparent substrate and the CNT layer is formed on the resin layer. Therefore, an optical filter 10 having a satisfactory environment resistance can be manufactured.

Then, a second manufacturing method for forming a CNT layer on a transparent substrate will be explained. First, coating, printing, or the like is applied to a substrate such that a resin that contains CNTs dispersed by means of a binder is coated or printed thereon. Then, the resulting resin layer containing the CNTs is burned so that a CNT layer is formed. The CNT layer is formed to about 0.1 to 100 μm.

Then, a screen printing plate or a metal mask that has openings that match the shape of the optical filter is formed on the upper surface of the CNT layer, and printing, coating, or the like is applied to the upper surface of the CNT layer such that a resin is printed or coated.

Then, the layered product formed of the resin layer and the CNT layer is transferred to a transparent substrate. At this time, the layered product is transferred such that the transparent substrate and the resin layer of the layered product contact.

Thus, the flat plate 11 of the optical filter 10 is completed. Then, the flat plate 11 is cut into the shape of the optical filter 10, and the rotation pin 12 and the actuation pin 13 are attached to the optical filter 10 with a bonding agent or the like. Thus, the optical filter 10 is completed.

Next, a third manufacturing method will be explained. First, a screen printing plate or a metal mask that has openings that match the shape of the optical filter is formed on a transparent substrate, and printing, coating or the like is applied to the transparent substrate such that a resin that contains a dye is printed or coated thereon.

After the resin that contains the dye is printed or coated on the transparent substrate, a resin layer that contains CNTs is formed on a surface of the transparent substrate on which the resin that contains the dye is printed or the like. Then, burning is conducted, for example, at about 100 degrees C. for about one hour so that the CNTs become a layer. The CNT layer is formed to a thickness of about 0.1 to 100 μm.

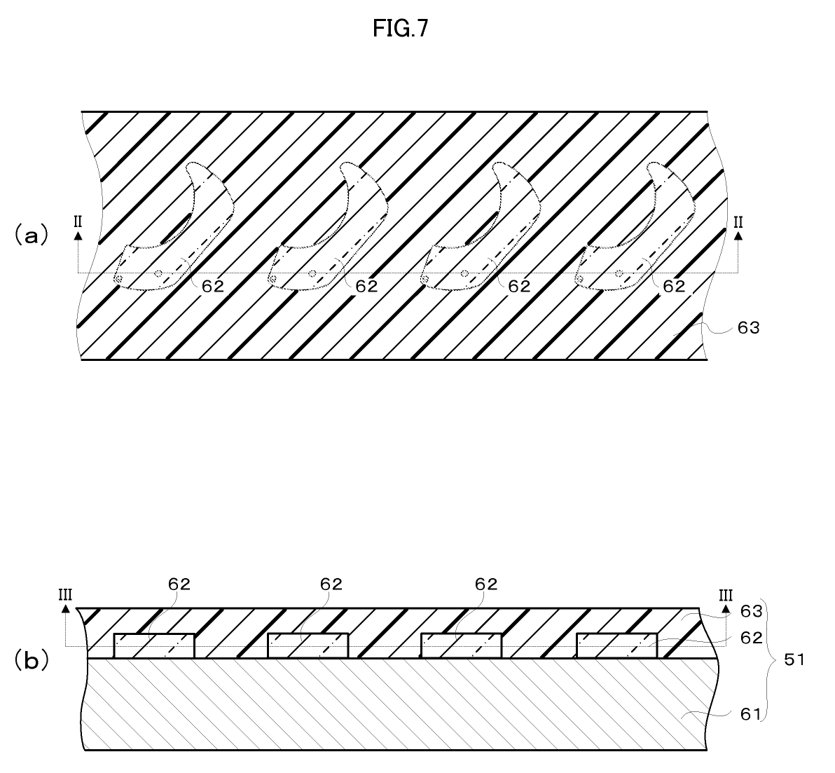

Thus, as shown in FIG. 7 (b), a flat plate 51, in which resin layers 62 are cyclically printed and sandwiched between the transparent substrate 61 and the CNT layer 63 to make the flat plate 51a layered body, is completed. Then, the flat plate 51 is cut into the shape of the optical filter 10, and the rotation pin 12 and the actuation pin 13 are attached to the optical filter 10 with a bonding agent or the like. Thus, the optical filter 10 is completed.

In the third manufacturing method, if the flat plate 51 is cut into a shape similar to the shape of the resin layer and larger than the resin layer, the resin that contains the CNTs covers the side surfaces of the resin layer. Practically, a region for letting light enter needs to be secured in cutting. Hence, the transparent substrate and the resin that contains the CNTs hermetically seal the resin that contains the dye. Accordingly, the resin that contains the dye is not exposed to the outside. Hence, moisture, etc. do not adhere to the resin that contains the dye, and the optical filter thus acquires a preferable environment resistance.

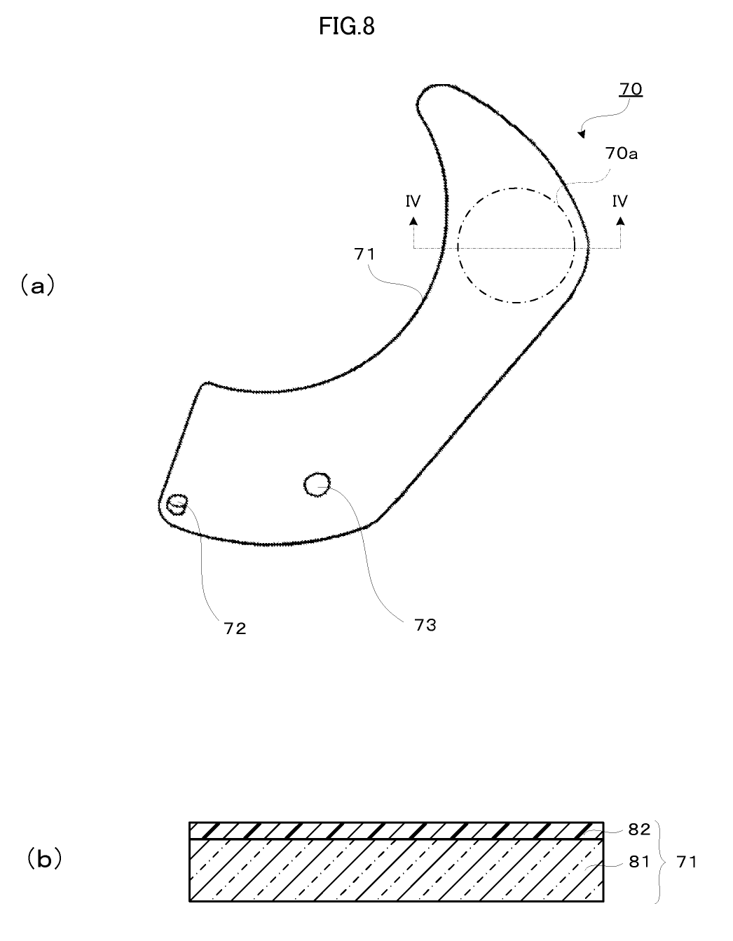

The present invention is not limited to the embodiments described above, but can be modified or applied in various manners. For example, in the embodiment described above, the configuration of forming the resin layer 32, in which a dye is dispersed, on the transparent substrate 31 is presented as an example. However, the present invention is not limited to this, but the transparent substrate may be omitted as in an optical filter 70 shown in FIGS. 8 (a) and 8 (b). As shown in FIGS. 8 (a) and 8 (b), the optical filter 70 has a light attenuation region 70a, and further, a flat plate 71, a rotation pin 72, and an actuation pin 73. The flat plate 71 includes a resin layer 81 in which a dye is dispersed, and a CNT layer 82 formed on the resin layer. Since this embodiment likewise has the CNT layer 82 formed on the resin layer 81, it can attenuate ultraviolet that is to reach the resin layer 81 and seal the resin layer 81 from moisture adhesion, and gives the optical filter 70 a preferable environment resistance.

The optical filter needs not be a filter that has flat absorptivity regardless of wavelength, but may be a filter that absorbs only short wavelengths, or a filter that absorbs a specific wavelength. Such modifications become available based on the kinds of dyes to be dispersed in the resin layer.

The embodiment described above has explained the case of constituting the resin layer with one layer, as an example. The present invention is not limited to this, but the resin layer may be constituted with multiple layers.

The explanation has been based on the configuration of rotating the optical filter 10 about the rotation pin 12, which is the rotation center, by putting the actuation pin 13 into operation by an actuator. The present invention is not limited to this. For example, appropriate modifications are available based on configurations for driving the optical filter 10, including, for example, providing only an actuation pin and rotating the optical filter 10 by rotating the actuation pin by means of an actuator or the like. The rotation pin 12 and the actuation pin 13 may exist on the same plane. The optical filter 10 may further be provided with a guide.

The resin layer 32 and the CNT layer 62 need not be formed over the entire surface of the transparent substrate 31, and it is enough if they can cover at least the light attenuation region 10a. Further, either of the resin layer 32 and the CNT layer 62 may be formed over the entire surface of the transparent substrate 31, and either of them may be formed over an area that covers at least the light attenuation region 10a.

The embodiment described above has explained the configuration of forming the CNT layer 33 on the outermost surface to which light enters, as an example. The present invention is not limited to this. For example, the optical filter 10 may have the CNT layer 33 formed on the transparent substrate 31 and the resin layer 32 formed on the CNT layer 33. In this case, if the optical filter 10 is set such that the CNT layer 33 faces the light entrance side, light that is to pass through the light attenuation region 10a enters the transparent substrate 31, goes through the CNT layer 33, and exits the resin layer 32. This configuration can also reduce the intensity of ultraviolet included in the light entering the resin layer 32 and prevent deterioration of the dye dispersed in the resin layer 32.

The present application is based on Japanese Patent Application No. 2006-264554 filed with the Japanese Patent Office on Sep. 28, 2006, the content of which is incorporated herein.

### INDUSTRIAL APPLICABILITY

The optical filter according to the present invention is useful as a filter that is used in optical instruments such as digital cameras that are often exposed to ultraviolet or moisture.

1. An optical filter that attenuates light having a predetermined wavelength, comprising:
at least one resin layer containing a material that absorbs light having a predetermined wavelength; and
a carbon layer in which a carbon-based material is dispersed,
wherein the resin layer is formed on one surface of the carbon layer, and light that passes through the carbon layer enters the resin layer.

2. The optical filter according to claim 1,
wherein the resin layer is formed on a substrate having light transmissivity.

3. The optical filter according to claim 1,
wherein the material that absorbs light having the predetermined wavelength is polyethylenedioxythiophene.

4. The optical filter according to claim 1,
wherein the carbon-based material is comprised of carbon nanotubes.

5. The optical filter according to claim 4,
wherein the carbon nanotube has a diameter of 300 nm or smaller.

6. The optical filter according to claim 5,
wherein the carbon nanotube is mixed at a rate of 0.01 to 20 weight %.

7. A method for manufacturing an optical filter, comprising:
a resin layer forming step of forming at least one resin layer containing a material that absorbs light having a predetermined wavelength; and
a carbon layer forming step of forming a carbon layer in which a carbon-based material is dispersed on the resin layer,
wherein at the carbon layer forming step, the carbon layer is formed on a light entrance side of the optical filter, such that light that passes through the carbon layer enters the resin layer.

8. The method for manufacturing the optical filter according to claim 7,
wherein the resin layer is formed on a substrate having light transmissivity.

9. A method for manufacturing an optical filter, comprising:
a carbon layer forming step of forming at least one carbon layer in which a carbon-based material is dispersed; and
a resin layer forming step of forming a resin layer containing a material that absorbs light having a predetermined wavelength, on the carbon layer,
wherein a carbon-resin layer that includes the carbon layer formed at the carbon layer forming step and the resin layer formed at the resin layer forming step is transferred to a substrate having light transmissivity, such that the resin layer and the substrate having light transmissivity contact, and
at the resin layer forming step, the formation is performed in such a way that the carbon layer is positioned in a light entrance side of the optical filter so that light that passes through the carbon layer enters the resin layer.

10. A method for manufacturing an optical filter, comprising:
a resin printing step of printing a resin containing a material that absorbs light having a predetermined wavelength, on a substrate having light transmissivity; and
a carbon layer forming step of forming a carbon layer in which a carbon-based material is dispersed, on a surface, on which the resin is printed in the resin printing step, of a printed product,
wherein at the carbon layer forming step, the formation is performed in such a way that the carbon layer is positioned in a light entrance side of the optical filter so that light that passes through the carbon layer enters the resin.
